(19) United States
(12) Patent Application Publication
(10) Pub. No.: US 2009/0309870 A1
(43) Pub. Date: Dec. 17, 2009

(54) ELECTROPHORETIC DISPLAY DEVICE, DRIVING METHOD FOR ELECTROPHORETIC DISPLAY DEVICE, AND ELECTRONIC APPARATUS

(75) Inventor: Yoshiki Takei, Matsumoto-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/465,848

(22) Filed: May 14, 2009

(30) Foreign Application Priority Data
Jun. 13, 2008 (JP) 2008-155316

(51) Int. Cl. G09G 5/00; G09G 3/34

(52) U.S. Cl. 345/214; 345/107

(57) ABSTRACT

A driving method for an electrophoretic display device that includes opposing first and second substrates provided so as to sandwich an electrophoretic element having an electrophoretic particle, a plurality of first electrodes formed on the first substrate at an electrophoretic element side, and a second electrode which is formed on the second substrate at an electrophoretic element side and is opposed to the plurality of first electrodes. The driving method for the electrophoretic display device includes (a) applying a first electric potential to a part of the plurality of first electrodes, (b) applying a second electric potential different from the first electric potential to a part of any other electrodes of the first electrodes, and (c) driving the electrophoretic element. The second electrode is in an electrically isolated condition.

### BACKGROUND

1. Technical Field

The present invention relates to an electrophoretic display device, a driving method for the electrophoretic display device, and an electronic apparatus.

2. Related Art

An electrophoretic display device is known that has a plurality of microcapsules arranged in a plane between a couple of substrates. JP-A-2006-259243 is an example of the related art. In this type of electrophoretic display device, a voltage is applied across a transparent electrode formed on a substrate at a display side and a driving electrode formed on a substrate at a rear face side (opposite side of the display side) so that an electrophoretic particle (charged particle) encapsulated in a microcapsule is attracted to either one of the electrodes, thereby performing display.

A driving method for an electrophoretic display device disclosed in the above related art is preferable to cause an electrophoretic particle in a microcapsule to be attracted to a transparent electrode or a driving electrode. However, since a leakage current flows between the transparent electrode and the driving electrode via the microcapsule, high power consumption is required which is disadvantageous for a display unit of a mobile device.

### SUMMARY

An advantage of some aspects of the present invention is that it provides a driving method for an electrophoretic display device having low power consumption while suppressing occurrence of a leakage current. Another advantage of the invention is that it provides an electrophoretic display device capable of being driven by low power.

A driving method according to a first aspect of the invention is disclosed for driving an electrophoretic display device that includes opposing first and second substrates provided so as to sandwich an electrophoretic element having an electrophoretic particle, a plurality of first electrodes formed on the first substrate at an electrophoretic element side, and a second electrode which is formed on the second substrate at an electrophoretic element side and is opposed to the plurality of first electrodes, the second electrode being in an electrically isolated condition. The driving method includes (a) applying a first electric potential to a part of the plurality of first electrodes, (b) applying a second electric potential different from the first electric potential to a part of any other electrodes of the first electrodes, and (c) driving the electrophoretic element.

In accordance with the above driving method, two kinds of different electric potentials are applied to the first electrodes under a condition that the second electrode is electrically isolated. As a result, the electric potential of the second electrode in the electrically isolated condition is determined depending on a potential distribution of the first electrodes to be stabilized in an intermediate electric potential between the first electric potential and the second electric potential. Consequently, electric potential differences are generated between the first electrodes applied with the first electric potential and the second electrode, and between the first electrodes applied with the second electric potential and the second electrode, respectively. The electrophoretic elements on the first electrodes are driven by the respective electric fields generated by virtue of the electric potential differences. Accordingly, it is possible to display an image in accordance with the first electric potential and the second electric potential.

In accordance with the invention, a voltage applied to the electrophoretic element can be lowered as compared to a driving method heretofore employed for driving the electrophoretic element by applying potentials to a first electrode and a second electrode, respectively. As a result, it is possible to reduce a leakage current flowing between the first electrode and the second electrode through the electrophoretic element. Consequently, the electrophoretic display device can be driven by low consumption power.

It is preferable that a total area of the first electrodes to be applied with the second electric potential is roughly the same as a total area of the first electrodes to be applied with the first electric potential.

In accordance with the above driving method, since the electric potential difference between the first electrodes maintained in the first electric potential and the second electrode can be made roughly the same as the electric potential difference between the first electrodes maintained in the second electric potential and the second electrode, it is possible to uniformly drive the electrophoretic elements. In addition, the leakage current can be markedly reduced.

It is preferable that a total area of the first electrodes to be applied with the second electric potential is not less than one time but equal to lower than three times a total area of the first electrodes to be applied with the first electric potential. When a difference between the total areas of the first electrodes applied with different electric potentials is enlarged, the leakage current tends to increase and a response speed at a wide area side is reduced. Therefore, the difference in the areas of the first electrodes applied with different electric potentials is made to be not greater than three times so that it is possible to performing the display by a reasonable response speed.

It is preferable to vary at least one of the first and second electric potentials to be applied to the first electrode or varying a time period for applying the electric potential to the first electrode in accordance with an area ratio of a total area of the first electrodes to be applied with the first electric potential to a total area of the first electrodes to be applied with the second electric potential. In accordance with the above driving method, it is possible to suppress lowering of the response speed in a case where the difference between the total areas of the first electrodes applied with different electric potentials is large so that comfortable displaying operations can be carried out irrespective of a style of a displayed image.

The first electrode except the first electrode applied with the first or second electric potential may be made in an electrically isolated condition. In accordance with the above driving method, an electric potential difference is not generated between the first electrode in a region where a display state is not changed and the second electrode so that a ratio of the electrophoretic elements applied with a voltage to all of the electrophoretic elements is reduced, thereby entirely reducing the leakage current.

It is preferable that the first electrode to be applied with the first electric potential is disposed out of an effective display region of the electrophoretic display device. One group of the first electrodes in the first electrodes applied with different electric potentials can be made not to be visually observed by a user and substantially not to contribute to the displaying.

In a case where the electrophoretic element is driven only by applying the electric potential to the first electrode, it is necessary to apply at least two kinds of electric potentials to the first electrodes in order to define the electric potential of the second electrode. However, in a case where all of the first electrodes are made in the same electric potential, the electrophoretic elements are not able to be driven so that an erasing operation for making the entirety of the effective display region to be in the same gradation could not be carried out by the electrophoretic display device by itself.

Contrary to the above, by using the driving method of the invention, it is possible that the first electrodes in the effective display region are made in the same electric potential and the entirety of the effective display region can be transited to be in the same gradation. Consequently, it is possible to improve freedom of displaying in the effective display region by the above driving method.

A driving method according to a second aspect of the invention is disclosed for driving an electrophoretic display device that includes opposing first and second substrates provided so as to sandwich an electrophoretic element having an electrophoretic particle, a plurality of first electrodes formed on the first substrate at an electrophoretic element side, and a second electrode which is formed on the second substrate at an electrophoretic element side and is opposed to the plurality of first electrodes. The driving method includes (d) displaying an image by applying a first electric potential to a part of the plurality of first electrodes, applying a second electric potential different from the first electric potential to a part of any other electrodes of the first electrodes and applying a predetermined electric potential to the second electrode, (e) refreshing by applying an electric potential corresponding to the first and second electric potentials in the displaying of the image to the plurality of first electrodes while making the second electrode to be in an electrically isolated condition.

In accordance with the above driving method, since displaying is performed by applying a voltage across the first electrodes and the second electrode in the step (d) of displaying an image, it is possible to display the image in a high speed. Since the electrophoretic element is driven under a condition that the second electrode is electrically isolated in the step (e) of refreshing, it is possible to reduce a leakage current. Consequently, it is possible to realize the electrophoretic display device capable of satisfying both of a comfortable displaying operation and a power saving property.

An electrophoretic display device according to a third aspect of the invention includes opposing first and second substrates provided so as to sandwich an electrophoretic element having an electrophoretic particle, a plurality of first electrodes formed on the first substrate at an electrophoretic element side, and a second electrode which is formed on the second substrate at an electrophoretic element side and is opposed to the plurality of first electrodes. The second electrode is in an electrically isolated condition.

In accordance with the above configuration, by applying two kinds of different electric potentials to the plurality of first electrodes, the second electrode in the electrically isolated condition can be made in the intermediate electric potential between the two kinds of potentials applied to the first electrodes. As a result, the electrophoretic elements can be driven based on the electric potential difference generated thereby and can perform the displaying. Since it is possible to obviate the need of connection of a wire to the second electrode which is a necessary configuration in an existing electrophoretic display device, a productivity can be improved or an area of a casing trim can be narrowed by virtue of the simplification of the configuration.

The electrophoretic display device according to the invention may further include a control section for controlling application of an electric potential to the plurality of first electrodes. The control section may vary at least one of the first and second electric potentials to be applied to the first electrodes or vary a time period for applying the electric potential to the first electrodes in accordance with an area ratio of a total area of the first electrodes to be applied with the first electric potential to a total area of the first electrodes to be applied with the second electric potential.

In accordance with the above configuration, since the electric potential to be applied to the first electrode or the potential applying time period is controlled in accordance with the area ratio between the first electrodes applied with different electric potentials, it is possible to compensate the variation in a response speed depending on the ratio of the total areas, thereby realizing the electrophoretic display device capable of performing displaying by a uniform speed.

The control section may include a table in which the ratio is correlated to the first or second electric potential or the potential applying time period. With this configuration, the electrophoretic display device can readily, immediately acquire a correction value of the electric potential or the potential applying time period based on the ratio of the total areas. Note that, instead of the way of looking up the table, a way of computing the electric potential or the potential applying time period based on the ratio of the total areas can be used.

In addition, at least a part of the first electrodes may be disposed out of an effective display region of the electrophoretic display device. With the above configuration, it is possible to provide the electrophoretic display device capable of displaying the entire effective display region in the same gradation.

Next, an electronic apparatus according to a fourth aspect of the invention is equipped with the above electrophoretic display device. With the above configuration, it is possible to provide the electronic apparatus having a display unit superior in a power saving property.

### BRIEF DESCRIPTION OF THE DRAWINGS

The invention will be described with reference to the accompanying drawings, wherein like numbers reference like elements.

FIG. 1 a schematic structural view showing an electrophoretic display device according to a first embodiment of the invention.

FIG. 2 is a schematic view showing a cross-sectional structure of the electrophoretic display device 100 and an electrical configuration thereof.

FIG. 3 is a typical cross sectional view showing a microcapsule.

FIGS. 4A, 4B and 4C are explanatory views showing operations of the electrophoretic display device according to the first embodiment.

FIGS. 5A through 5D are explanatory views for explaining a leakage current.

FIG. 6 is a functional block diagram showing a controller provided to the electrophoretic display device according to a second embodiment.

FIG. 7 is a flowchart showing a driving method for the electrophoretic display device according to a third embodiment.

FIG. 8 is a timing chart corresponding to the driving method shown in FIG. 7.

FIG. 9A is a plan view showing an electrophoretic display device according to a forth embodiment.

FIG. 9B is a plan view showing a first substrate.

FIG. 10 is a cross sectional view corresponding to FIG. 9.

FIG. 11 is a plan view of a wrist watch of an embodiment of an electronic apparatus.

FIG. 12 is a perspective view showing an electronic paper of an embodiment of an electronic apparatus.

FIG. 13 is a perspective view showing an electronic notebook of an embodiment of an electronic apparatus.

### DESCRIPTION OF EXEMPLARY EMBODIMENTS

The preferred embodiments of an electrophoretic display device and a driving method for driving the same according to the invention will be described with reference to the accompanying drawings. It should be noted that embodiments described below show just examples of the invention, do not limit the scope of the invention, and can be modified within the scope and spirit of the invention. In addition, in the drawings, the scale or the number of members in the structure is made different from that in an actual structure so that the invention may be understood well.

### First Embodiment

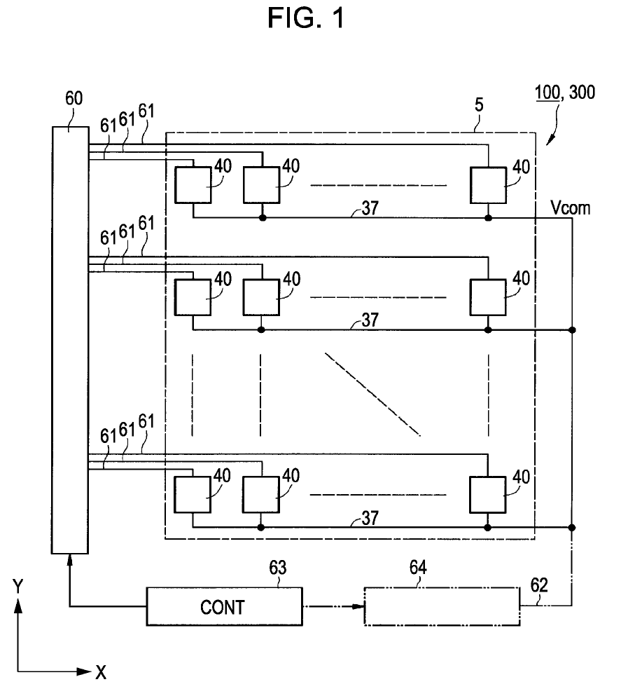

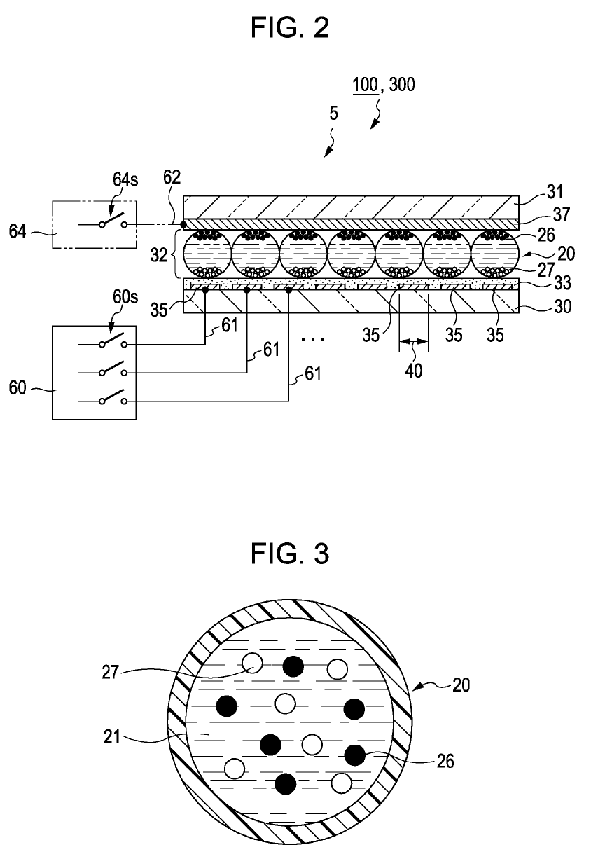

FIG. 1 is a schematic structural view showing an electrophoretic display device 100 according to a first embodiment of the invention. FIG. 2 is a schematic view showing a cross-sectional structure of the electrophoretic display device 100 and an electric configuration thereof.

The electrophoretic display device 100 includes a display section 5 having a plurality of pixels (segments) 40 arranged therein, a controller (control section) 63, and a pixel electrode driving circuit 60 connected to the controller 63. The pixel electrode driving circuit 60 is coupled to each of the pixels 40 through respective pixel electrode wires 61. The display section 5 is provided with a common electrode 37 common to the pixels 40 (see FIG. 2). In FIG. 1, the common electrode 37 is shown as a wire for convenience of illustration. The electrophoretic display device 100 is a segment driving type configured such that image data is transmitted to the pixel electrode driving circuit 60 from the controller 63 and an electric potential based on the image data is directly applied to each of the pixels 40.

As shown in FIG. 2, the display section 5 of the electrophoretic display device 100 is configured such that an electrophoretic element 32 is sandwiched between a first substrate 30 and a second substrate 31. A plurality of pixel electrodes (segment electrodes; first electrodes) 35 are formed on the first substrate 30 at the electrophoretic element 32 side, and a common electrode (second electrode) 37 is formed on the second substrate 31 at the electrophoretic element 32 side. The electrophoretic element 32 is configured such that a plurality of microcapsules 20 each having an electrophoretic particle encapsulated therein are arranged in a plane. The electrophoretic display device 100 displays an image formed by the electrophoretic element 32 on the display section 5 at the common electrode 37 side.

The first substrate 30 is made of glass or plastic and is not necessarily transparent because it is disposed at the opposite side of an image display face. The pixel electrode 35 is adapted to apply a voltage to the electrophoretic element 32. The pixel electrode 35 is formed such that a nickel plate and a gold plate are laminated on a Cu (copper) foil in this order, or formed of Al (Aluminum) or ITO (Indium-Tin Oxide). On the other hand, the second substrate 31 is made of glass or plastic, and is made to be transparent because it is disposed at an image display side. The common electrode 37 is adapted to apply a voltage to the electrophoretic element 32 together with the pixel electrode 35. The common electrode 37 is a transparent electrode formed of MgAg (Magnesium-Silver), ITO or IZO (Indium Zinc Oxide).

The pixel electrode driving circuit 60 is coupled to each of the pixel electrodes 35 through the respective pixel electrode wires 61. Switching elements 60s corresponding to the respective pixel electrode wires 61 are provided to the pixel electrode driving circuit 60. In this embodiment, a wire is not connected to the common electrode 37 so that the electrode 37 is electrically isolated from the others.

In general, the electrophoretic element 32 is formed at the second substrate 31 side beforehand and is handled in the form of an electrophoretic sheet including the electrophoretic element 32, the second substrate 31 and an adhesive layer 33. In a manufacturing process, the electrophoretic sheet is handled under a condition that a peelable sheet for protection is stuck to the surface of the adhesive layer 33. The display section 5 is formed such that the electrophoretic sheet from which the peelable sheet is peeled, is stuck to the first substrate 30 (having the pixel electrodes 35 formed thereon) which is formed in a separate manufacturing process. Therefore, the adhesive layer 33 is disposed at only the pixel electrode 35 side.

FIG. 3 is a typical cross sectional view showing the microcapsule 20. The microcapsule 20 is formed as a spherical shaped particle having a diameter of, for example, approximately 30 to 50 μm and is configured such that a dispersion medium 21, a plurality of white particles (electrophoretic particles) 27, and a plurality of black particles (electrophoretic particles) 26 are encapsulated in the microcapsule 20. As shown in FIG. 2, the microcapsule 20 is sandwiched between the common electrode 37 and the pixel electrode 35, and one or more microcapsules 20 are disposed in one pixel 40.

An outer shell portion (wall film) of the microcapsule 20 is formed of an acrylic resin such as polymethyl methacrylate or polyethyl methacrylate, a urea resin, or a polymer resin with a light transmissive property such as gum arabic. The dispersion medium 21 is a liquid for dispersing the white particles 27 and the black particles 26 in the microcapsule 20.

As the dispersion medium 21, water, an alcohol solvent (methanol, ethanol, isopropanol, butanol, octanol, or methyl cellosolve), an ester (ethyl acetate, or butyl acetate), a ketone (acetone, methyl ethyl ketone, or methyl isobutyl ketone), an aliphatic hydrocarbon (pentane, hexane, or octane), an alicyclic hydrocarbon (cyclohexane, or methylcyclohexane), an aromatic hydrocarbon (benzene, toluene, or benzene compound having long chained alkyl group (xylene, hexylbenzene, hebutylbenzene, octylbenzene, decylbenzene, nonylbenzene, undecylbenzene, dodecylbenzene, tridecylbenzene, or tetradecylbenzene)), halogenated hydrocarbon (dichloromethane, chloroform, carbon tetrachloride, or 1,2-dichloroethane), carboxylate, and other oils can be exemplarily used. Each of these materials can be used individually or a mixture of these materials can be used as the dispersion medium 21, and it is possible to combine a surfactant with the dispersion material.

The white particle 27 is a particle (polymer or colloid) formed of a white pigment such as, for example, titanium dioxide, Chinese white (zinc oxide), or antimony trioxide, and is charged, for example, to a negative potential. The black particle 26 is a particle (polymer or colloid) formed of a black pigment such as, for example, aniline black or carbon black, and is charged, for example, to a positive potential. It is possible to add if needed, to the pigments, a charging control agent made of a particle of an electrolyte, a surfactant, a metallic soap, a resin, a rubber, an oil, a varnish or a compound, a dispersant such as a titanate coupling agent, an aluminate coupling agent or a silane coupling agent, a lubricant agent, or a stabilizer. In addition, for example, a red, green, or blue pigment can be used instead of the black particle 26 or the white particle 27. With the above configuration, a red, green, or blue color can be displayed on the display section 5.

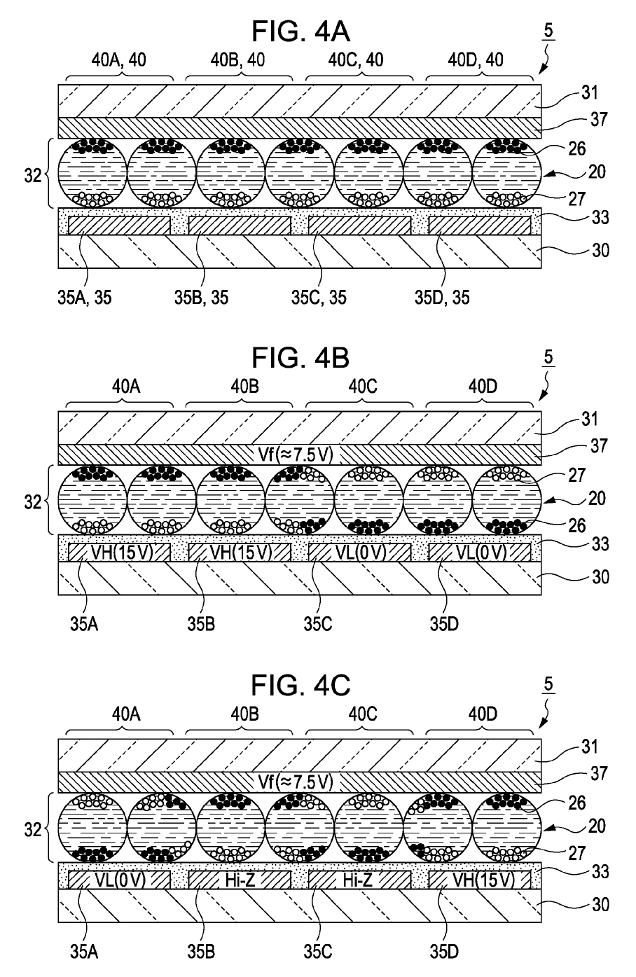

FIGS. 4A, 4B and 4C are explanatory views showing operations of the electrophoretic display device 100. FIG. 4A shows a condition that the entire portion of the display section 5 is displayed in black. FIG. 4B shows an operating condition when an image is displayed on the display section 5. FIG. 4C shows an operating condition when an image on the display section 5 is updated.

To simplify the explanation, FIGS. 4A, 4B and 4C show a case where the display section 5 is configured of four pixels (segments) 40A to 40D. The pixels 40A to 40D are respectively provided with pixel electrodes 35A to 30D, and the areas of the pixel electrodes 35A to 35D are the same as each other. The common electrode 37 common to the pixels 40A to 40D is provided to the second substrate 31 at the electrophoretic element 32 side.

First, under an initial condition shown in FIG. 4A, the black particles 26 are attracted toward the common electrode 37 and the white particles 27 are attracted toward the pixel electrodes 35A to 35D so that each of the pixels 40A to 40D is in a black display state. In order to display an image on the display section 5 under the above condition, an electric potential according to image data is applied to each of the pixel electrodes 35A to 35D of the respective pixels 40A to 40D as shown in FIG. 4B. That is, the image data is supplied to the pixel electrode driving circuit 60 from the controller 63 shown in FIG. 1, and then the electric potentials corresponding to the image data are applied to the respective pixel electrodes 35A to 35D of the pixels 40A to 40D from the pixel electrode driving circuit 60 via the pixel electrode wires 61. On the other hand, the common electrode 37 is electrically isolated so that the electric potential Vcom is a floating potential Vf.

In the embodiment shown in FIG. 4B, a high level potential VH (e.g., 15 V) is applied to the pixel electrodes 35A and 35B, and a low level potential VL (e.g., 0 V; GND) is applied to the pixel electrodes 35C and 35D. As a result, the floating potential Vf of the electrically isolated common electrode 37 is varied in accordance with an electric potential distribution (the electric potential and the area of each electrode) of the pixel electrodes 35A to 35D facing the common electrode 37 so that the floating potential Vf becomes an intermediate potential between the high level potential VH and the low level potential VL to be stabilized.

For example, in a case where the high level potential VH is 15 V and the low level potential VL is 0 V, the floating potential Vf becomes approximately 7.5 V which is the intermediate value because the total area of the areas of the pixel electrodes 35A and 35B is the same as the total area of the areas of the pixel electrodes 35C and 35D.

As described above, since the floating potential Vf of the common electrode 37 becomes the intermediate potential between the high level potential VH and the low level potential VL, an electric potential difference is generated for each portion between each of the pixel electrodes 35A to 35D and the common electrode 37 at the pixels 40A to 40D. As a result, an electric field generated by the electric potential difference acts on the electrophoretic element 32.

That is, in terms of pixels 40A and 40B, the pixel electrodes 35A and 35B in the high level potential VH are in the relatively high potential states and the common electrode 37 in the intermediate potential is in the relatively low potential state, thereby generating the electric fields on the portions between the electrodes, respectively. As a result, the negatively charged white particles 27 are attracted to the pixel electrodes 35A and 35B, and the positively charged black particles 26 are attracted to the common electrodes 37. Consequently, each of the pixels 40A and 40B maintains the black display state as shown in FIG. 4B.

On the other hand, in terms of the pixels 40C and 40D, the common electrode 37 in the intermediate potential is in the relatively high potential state and the pixel electrodes 35C and 35D in the low level potential VL are in the relatively low potential states, thereby generating the electric fields between the electrodes. Consequently, the negatively charged white particles 27 are attracted to the common electrodes 37, and the positively charged black particles 26 are attracted to the pixel electrodes 35C and 35D. Thus, the pixels 40C and 40D are displayed in white.

As described above, in the electrophoretic display device 100 according to the embodiment, although the common electrode 37 is electrically isolated, either one of the high level potential VH and the low level potential VL is applied to the pixel electrodes 35A to 35D formed on the first substrate 30 so that it is possible to display an image in accordance with arbitrary image data.

In addition, it is obviously possible to update a displayed image on the display section 5 in the electrophoretic display device 100. In the above case, as shown in FIG. 4B, by respectively applying potentials according to image data to all of the pixel electrodes 35 in the display section 5, an image according to new image data is overwritten in the display section 5 to be displayed.

Alternatively, when the display image is updated, a part of the pixel electrodes 35 can be made in an electrically isolated condition (high impedance state), as shown in FIG. 4C. To be more detailed, in a case where the display state shown in FIG. 4B is transited to the display state shown in FIG. 4C, the pixel electrodes 35B and 35C of the pixels 40B and 40C whose gradations are not changed before and after the display updating operation, are made in high impedance states, and then the low level potential VL and the high level potential VH are respectively applied to the pixel electrodes 35A and 35D of the pixels 40A and 40D whose display states are to be switched.

In the above case, since the electric potential is not applied to the pixel electrodes 35B and 35C, the floating potential Vf of the common electrode 37 is determined by virtue of a balance between the electric potential of the pixel electrode 35A and the electric potential of the pixel electrode 35D. Since the areas of the pixel electrodes 35A and 35D are the same as each other, the floating potential Vf becomes an electric potential roughly equal to the intermediate potential (VH+VL)/2 between the high level potential VH and the low level potential VL. The electrophoretic elements 32 are driven by the electric fields generated by the electric potential differences between the pixel electrode 35A and the common electrode 37 and between the pixel electrode 35D and the common electrode 37. As a result, the black display state of the pixel 40A is transited to the white display state and the white display state of the pixel 40D is transited to the black display state.

On the other hand, in terms of the pixels 40B and 40C whose pixel electrodes 35B and 35C are made to be in the high impedance state, since an electric potential difference is substantially generated between each of the pixel electrodes 35B and 35C and the common electrode 37, the electrophoretic elements 32 are not driven so that the electrophoretic elements 32 maintain the respective black display state and white display state.

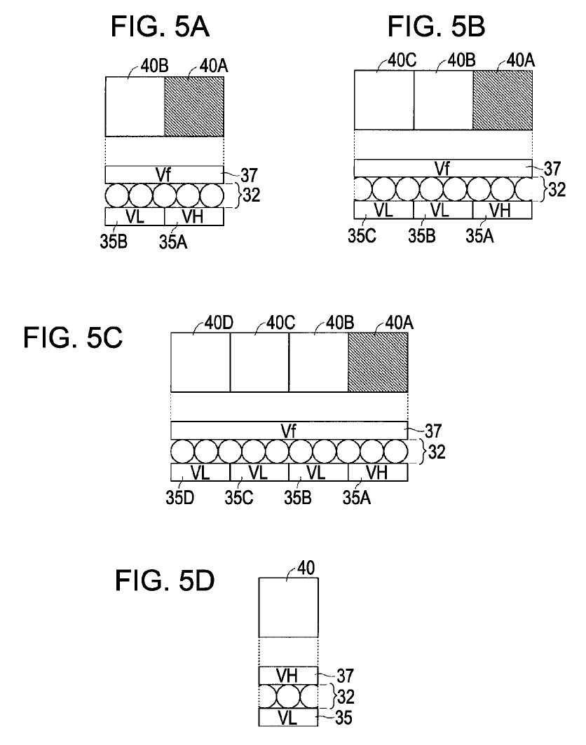

In accordance with the electrophoretic display device 100 and the driving method therefor according to the embodiment, it is possible to reduce the leakage current during the operation for displaying an image as compared to an electrophoretic display device heretofore employed in which a voltage is applied to each of a pixel electrode and a common electrode to drive electrophoretic elements. The leakage current is described below with reference to FIGS. 5A through 5D.

FIGS. 5A through 5D are explanatory views for explaining the leakage current in the electrophoretic display device 100 of the embodiment. Each of FIGS. 5A through 5C includes a plan view (upper part) of the pixel 40 and a cross sectional view (lower part) corresponding to the plan view in a case where a ratio of the pixels in the white display states to the pixels in the black display states is varied from 1:1 to 1:3. FIG. 5D includes a plan view (upper part) and a cross sectional view (lower part) corresponding to the upper part in a case where a pixel is made to be in a white display state by the heretofore used driving method shown for comparison purposes.

The inventor of this invention carried out measurement of a leakage current in a case where the pixels 40 (40A to 40D) initially all in the black display state were transited to be in the states shown in FIGS. 5A to 5D. First, when two pixels shown in FIG. 5A were driven, both of the pixels 40A and 40B having the same areas were made to be in the black display state. After that, as shown in FIG. 5A at the lower part, the high level potential VH was applied to the pixel electrode 35A of the pixel 40A and the low level potential VL was applied to the pixel electrode 35B of the pixel 40B so that the state of the pixel 40B was switched to the white display state while maintaining the black display state of the pixel 40A. In the above series of operations, the leakage current between the pixel electrode 35 and the common electrode 37 was measured.

In addition, in a case shown in FIGS. 5B and 5C, an operation for changing a condition that all of the pixels 40A to 40C (40A to 40D) were in the black display state, to a condition that pixels 40B and 40C (and 40D) were in the white display state, was carried out similarly to that described above, and then the leakage current was measured at that time. For comparison purposes, in terms of one of the pixels 40 shown in FIG. 5D, the low level potential VL was applied to the pixel electrode 35, and the high level potential VH was applied to the common electrode 37 so that the one the pixels 40 in the black display state was switched to the white display state, and then the leakage current was measured at that time.

The measurement results of the respective examples shown in FIGS. 5A to 5D are as follows:
(A) 1.158 μA (Area ratio 1:1)
(B) 1.529 μA (Area ratio 1:2)
(C) 1.695 μA (Area ratio 1:3)
(D) 2.160 μA (Related Art)

As is apparent from the above results, the driving method according to the invention in which the electric potential is applied to the pixel electrode 35 while electrically isolating the common electrode 37, enables significant reduction of the leakage current as compared to an existing driving method. This is possibly because the common electrode 37 has an intermediate potential between, for example, the high level potential VH and the low level potential VL, and the voltage applied to the electrophoretic element 32 becomes substantially low. In addition, even when using the driving method according to the invention, causing the area ratio of the pixels 40 maintaining their display state to the pixels 40 switching their display state to approach the ratio of 1:1 enables effective reduction of the leakage current.

By adopting the driving method, as in the above modified example, in which the pixel electrodes 35 of the pixels 40 maintaining their display state are in the high impedance state, a voltage is not applied to a part of the electrophoretic elements 32 in the display section 5. As a result, it is possible to reduce the leakage current in the entire display section 5. In the above case, however, it is necessary to make the electric potentials of a part of the pixel electrodes 35 and the electric potentials of a part of any other pixel electrodes 35 in the display section 5 to be different from each other (for example, high level potential VH, low level potential VL).

In the electrophoretic display device 100 according to the embodiment, the displaying or updating of an image can be carried out when the area ratio between pixels 40 maintaining their display states and pixels 40 switching their display states is in a range from 1:1 to 1:3. However, the further the area ratio is from the ratio of 1:1, the more the electric field acting on the electrophoretic elements 32 of the pixels (white pixels in FIG. 5) in the wider area is reduced, thereby lowering the responsiveness. Consequently, it is preferable to operate the electrophoretic elements 32 in the above ratio as much as possible.

As described above in detail, in accordance with the above electrophoretic display device 100 of the embodiment, the electric potentials are applied to the plurality of pixel electrodes 35 in the display section 5 to drive the electrophoretic elements 32 under a condition that the common electrode 37 is electrically isolated so that the leakage current flowing between the pixel electrodes 35 and the common electrode 37 can be reduced during the driving. As a result, it is possible to provide the electrophoretic display device with low power consumption suitable for mobile electronic apparatuses.

Since the electrophoretic display device 100 has the structure in which the electric potential is not applied to the common electrode 37, a driving circuit for driving the common electrode 37 can be obviated, and a conductive structure for connecting a wire or a circuit on the first substrate 30 to the common electrode 37 formed on the second substrate 31 can be also obviated. As a result, it is possible to simplify the structure of the electrophoretic display device 100, to reduce the cost and to narrow an area of a casing trim.

### Second Embodiment

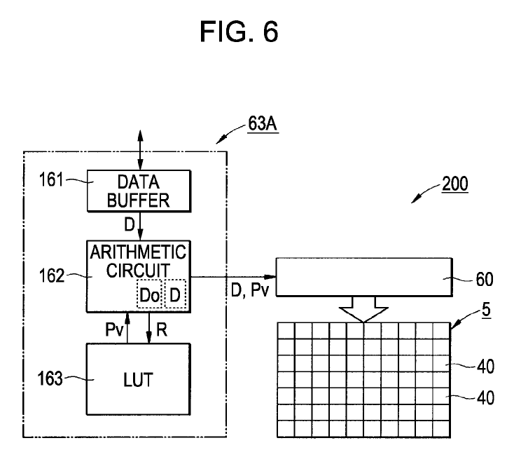

Next, a second embodiment is described below with reference to the drawings. FIG. 6 is a functional block diagram showing a controller 63A provided to an electrophoretic display device 200 according to the embodiment. Note that the structures except the controller 63A are common to the electrophoretic display device 100 of the first embodiment.

As described above, in the electrophoretic display device 100 of the first embodiment, the more the area ratio of the pixels 40 switching those display states to the pixels 40 maintaining those display states is separated from the ratio of 1:1, the more the responsiveness of the pixels 40 in the wide area is lowered. In order to solve the above problem, the electrophoretic display device 200 of the embodiment is configured so that an electric potential to be applied to the pixel electrodes 35 or a period of time for applying the electric potential are controlled in accordance with the area ratio.

As shown in FIG. 6, the controller 63A is equipped with a data buffer 161, an arithmetic circuit 162 and an LUT (Look Up Table) 163. Only the circuits necessary for the description below are shown In FIG. 6, so that the configuration is not necessarily consistent with the actual configuration of the controller 63A.

The data buffer 161 is adapted to hold image data D received from a host device and transmit the image data D to the arithmetic circuit 162. The arithmetic circuit 162 has a function of executing arithmetic processing in accordance with the received image data D, a function of looking up the LUT 163 and a function of supplying the image data D to the pixel electrode driving circuit 60, and includes a memory region for storing the plurality of pieces of image data D and Do. The LUT 163 is a table in which an area ratio R of pixels with display gradation to be updated to pixels with display gradation to be maintained is correlated to a potential correction parameter Pv.

In the controller 63A, when the image data D is supplied to the arithmetic circuit 162 from the data buffer 161, the arithmetic circuit 162 first confirms whether or not the inner memory region holds the image data Do. The image data Do is one which is received from the data buffer 161 just before the image data D and corresponds to an image currently displayed on the display section 5.

In a case where the image data Do is not stored in the memory region, the arithmetic circuit 162 directly outputs the image data D to the pixel electrode driving circuit 60 without performing the arithmetic processing. The pixel electrode driving circuit 60 supplies an electric potential based on the received image data D to the pixel 40 so that an image according to the image data D is displayed on the display section 5.

On the other hand, in a case where the image data Do is held in the memory region, the arithmetic circuit 162 stores the image data D received from the data buffer 161 to the memory region in the circuit and performs arithmetic processing in accordance with the image data D and the image data Do. To be specific, pieces of pixel data corresponding to the image data D and the image data Do are compared with each other, and then the pixel 40 with display gradation to be updated and the pixel 40 with display gradation to be maintained are determined. A total area (Sr) of the pixels 40 with display gradation to be updated and a total area (Sk) of the pixels 40 with display gradation to be maintained are computed by using area information prepared by each pixel 40. On the basis of the total areas, an area ratio R (=Sk/Sr) is computed.

After that, the arithmetic circuit 162 looks up the LUT 163 by using the area ratio R computed by the arithmetic processing to acquire the potential correction parameter Pv from the LUT 163. The potential correction parameter Pv is used for correcting the electric potential output from the pixel electrode driving circuit 60. To be specific, the grater the area ratio R is, the more the responsiveness of the display section 5 is reduced. Therefore, the potential correction parameter Pv is set to enable the correction for increasing the electric potential to be applied to the pixel electrode 35 in order to compensate the lowering of the responsiveness.

The arithmetic circuit 162 outputs the acquired potential correction parameter Pv to the pixel electrode driving circuit 60 together with the image data D. After outputting the image data D, the arithmetic circuit 162 discards the previous image data Do and stores the image data D to the memory region, and then goes into a state for waiting input of image data D of the next frame. The pixel electrode driving circuit 60 generates an electric potential to be supplied to the image electrode 35 of the pixel 40 in accordance with received image data D and corrects the generated potential by using the potential correction parameter Pv. The pixel electrode driving circuit 60 inputs the corrected potential to the image electrode 35.

With the above operations, the electrophoretic display device 200 displays an image on the display section 5. Since the electric potential to be applied to the pixel electrode 35 is adjusted in accordance with the image data D and the image data Do input prior to the image data D in the electrophoretic display device 200 of the embodiment, it is possible to prevent the response speed (displaying speed) from being markedly varied even when the area ratio R of the pixels 40 with display gradation to be updated to the pixels 40 with display gradation to be maintained is fluctuated by each frame. Consequently, it is possible to achieve the electrophoretic display device capable of displaying an image on the display section 5 by a uniform speed, and allowing a user to comfortably browse an image.

In this embodiment, the LUT 163 has the table in which the area ratio R is correlated to the potential correction parameter Pv. However, the potential correction parameter Pv can be replaced with a parameter for correcting a potential applying time period. Namely, the responsiveness is not compensated based on a level of the electric potential applied to the pixel electrode 35, but the time period for driving the electrophoretic elements 32 is controlled by varying the potential applying time period (pulse width or number of pulses) with respect to the pixel electrode 35, thereby improving the responsiveness. In the above case, the correction parameter for the potential applying time period is set so as to make the potential applying time period longer as the area ratio R is greater.

The data group forming the LUT 163 may include only actually measured values and include the actually measured values and calculated values for complementing the measured values. Alternatively, the arithmetic circuit 162 may be provided with a function f (R) for obtaining the potential correction parameter Pv based on the area ratio R without using the LUT 163 to be looked up.

### Third Embodiment

While describing the configuration in which a wire is not connected to the common electrode 37 in the first and second embodiments, it is possible to use a configuration in which an electric potential can be applied to the common electrode 37 as in an existing configuration. An electrophoretic display device 300 according to the embodiment includes a common electrode drive circuit 64 connected to the controller 63 in addition to the structure of the electrophoretic display device 100 shown in FIG. 1. The common electrode drive circuit 64 and the common electrode 37 are connected via a common electrode wire 62. As shown in FIG. 2, the common electrode driving circuit 64 is configured so as to have a switching element 64s. The common electrode driving circuit 64 can perform applying of an electric potential and electric shutting-off (making a high impedance state) with respect to the common electrode 37.

In the electrophoretic display device 300 of the embodiment, the electric potential can be applied to the pixel electrode 35 similarly to the above first embodiment while the common electrode 37 is made in the high impedance state by the common electrode driving circuit 64. As a result, the electrophoretic display device 300 can perform displaying or updating of an image in the same manner as in the first embodiment.

In addition, since the electric potential can be applied to the common electrode 37 in the electrophoretic display device 300, it is possible to perform an erasing operation for making the entirety of the display section 5 to be displayed in white or in black similarly to an existing electrophoretic display device. In the electrophoretic display device 100 of the first embodiment, the electric potential of the common electrode 37 is determined based on the electric potential distribution of the pixel electrodes 35 so that electrodes 35 in the display section 5 are necessary to be in at least two kinds of different electric potentials. For example, even when the high level potential VH is applied to all of the pixel electrodes 35 in order to make all of the pixels 40 to be in the black display states, the floating potential Vf of the common electrode 37 also becomes the high level potential VH. As a result, the electrophoretic elements 32 are not driven so that the entirety of the display section is not displayed in black. Contrary to the above, when the common electrode 37 is configured so as to be applied with the electric potential, the applying of the electric potential to the common electrode 37 makes it possible to allow the entirety the display section to be displayed in black or white.

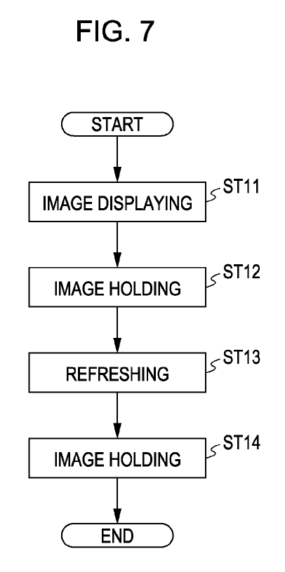

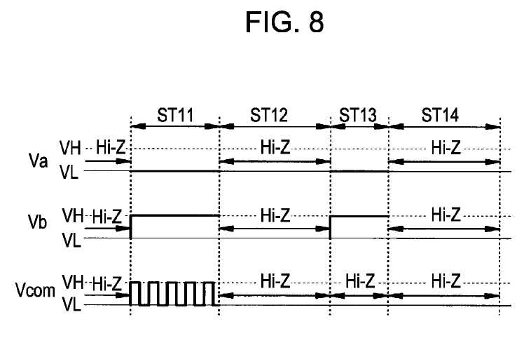

Next, a preferable driving method for driving the electrophoretic display device 300 of the embodiment is described below. FIG. 7 is a flowchart showing the driving method of the embodiment. FIG. 8 shows a timing chart corresponding to the driving method shown in FIG. 7.

As shown in FIG. 7, the driving method of the embodiment includes an image displaying step ST11, a first image holding step ST12, a refreshing step ST13 and a second image holding step ST14. The timing chart shown in FIG. 8 indicates operations in which two pixels 40A and 40B shown in FIG. 5A are respectively set in the white and black display states and the display states are maintained after that. Va designates an electric potential of the pixel electrode 35A in the pixel 40A, Vb designates an electric potential of the pixel electrode 35B in the pixel 40B and Vcom designates an electric potential of the common electrode 37.

First, in the image display step ST11, the low level potential VL and the high level potential VH are applied to the pixel electrodes 35A and 35B of the pixels 40A and 40B, respectively. A pulse having a rectangular shaped waveform including the low potentials VL and the high potentials VH, the low potential VL and the high potential VH being periodically repeated, is applied to the common electrode 37. As a result, an electric field is generated between the pixel electrode 35A (low level potential VL) and the common electrode 37 at the pixel 40A during the time period while the electric potential Vcom of the common electrode 37 is in the high level potential VH. The electrophoretic elements 32 are driven by the electric field so that the pixel 40A is set in the white display state. On the other hand, at the pixel 40B, an electric field is generated between the pixel electrode 35B (high level potential VH) and the common electrode 37 to drive electrophoretic elements 32 during the time period while the electric potential Vcom of the common electrode 37 is in the low level potential VL. As a result, the pixel 40B is set in the black display state.

After an image is displayed on the display section 5, the process is moved to the first image holding step ST12. In the first image holding step ST12, the pixel electrodes 35A and 35B and the common electrode 37 are in the high impedance states in which they are electrically isolated from each other, as shown in FIG. 8. As a result, the electrophoretic element 32 is not applied with the voltage so that the displayed image is maintained without consuming the electric power by the display section 5, the pixel electrode driving circuit 60 and the common electrode driving circuit 64.

After the process is moved to the first image holding step ST12 and a predetermined time period has elapsed, the refreshing step ST13 is carried out. The electrophoretic element 32 has a memory property so that it can maintain its display state (state of the electrophoretic particle in the electrophoretic element). However, the contrast is reduced with the lapse of time because of movement of the electrophoretic element. For this reason, the refreshing step ST13 is carried out before the contrast is notably reduced so that the contrast is restored and the good display condition can be maintained.

In the embodiment, the driving method according to the invention is used in the refreshing step ST13. Namely, while the common electrode 37 is set electrically isolated to be in the high impedance state, the low level potential VL and the high level potential VH are applied to the pixel electrodes 35A and 35B, respectively.

Consequently, as above described with reference to FIG. 5A, since the potential of the common electrode 37 in the high impedance state becomes near the intermediate potential (VH+VL)/2 between the potentials of pixel electrode 35A and 35B to be stabilized, electric potential differences are generated between the pixel electrodes 35A and 35B and the common electrode 37, respectively. As a result, the electrophoretic elements 32 are driven by the electric fields by virtue of the electric potential differences. With the above configuration, the white particles 27 are attracted to the common electrode 37 side at the pixel 40A, and the black particles 26 are attracted to the common electrode 37 side at the pixel 40B so that the contrast of the display section 5 is restored.

After the refreshing step ST13 is carried out, the process is moved to the second image holding step ST14. In the second image holding step ST14, the pixel electrodes 35A and 35B and the common electrode 37 are set in the high impedance states as the same manner as the first image holding step ST12 so that it is possible to maintain the displayed image without consuming the power.

With the driving method of the embodiment described above, since the predetermined potentials are applied to the pixel electrodes 35A and 35B and the common electrode 37, respectively to perform displaying of an image in the image displaying step ST11, the high speed displaying with the enough contrast can be performed irrespective of a structure (gradation distribution) of the displayed image. On the other hand, in the refreshing step ST13 after displaying an image, since the contrast of the displayed image is restored or maintained only by applying the potentials to pixel electrodes 35a and 35b, a leakage current in the refreshing step ST13 can be reduced and the power consumption can be suppressed. Therefore, the driving method of the embodiment makes it possible to display an image without giving uncomfortable feeling to a user and to maintain the display image while suppressing the power consumption.

In the above driving method, it is described that a case using a so-called common swing driving method in which the pulse with the rectangular waveform having the high level potentials VH and the low level potentials VL repeated at a predetermined cycle is applied to the common electrode 37 in the image displaying step ST11. However, the driving method is not limited to the above. For example, it is possible to adopt a driving method in which a negative potential (low level) and a positive potential (high level) are applied to the pixel electrodes 35A and 35B, respectively under a condition that the common electrode 37 is maintained in the ground potential (0 V).

### Fourth Embodiment

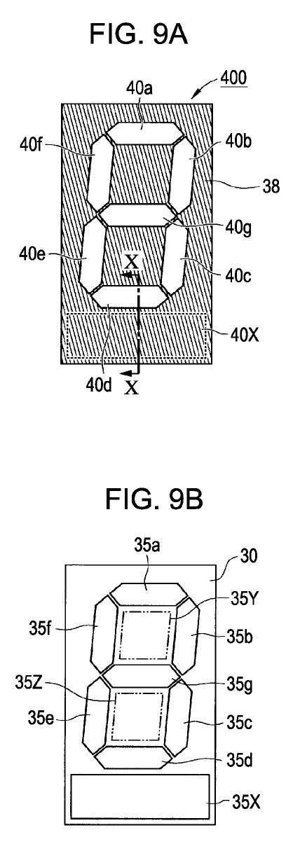

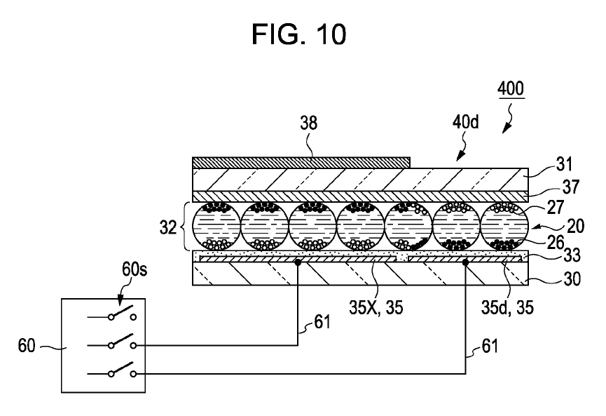

Next, a fourth embodiment according to the invention is described below with reference to the drawings. FIG. 9A is a plan view showing a seven segment type electrophoretic display device 400 and FIG. 9B is a plan view showing the first substrate 30 having the pixel electrodes arranged thereon. FIG. 10 is a cross sectional view at a position taken along A-A′ line in FIG. 9A. The electrophoretic display device 400 has a basic structure common to the electrophoretic display device 100 of the first embodiment. The following description is made by assuming that the electrophoretic display device 400 has all of the structural elements of the electrophoretic display device 100 unless there is a specific provision.

As shown in FIG. 9A, the electrophoretic display device 400 includes seven pixels (segments) 40a to 40g disposed in a shape of “8” and a light shading film 38 having opening sections corresponding to the pixels 40a to 40g. In addition, the electrophoretic display device 400 has a dummy pixel 40X (dummy segment) provided below the pixel 40d. The dummy pixel 40X is disposed in a region having formed thereon the light shading film 38 so as not to be seen by a user. The color of the light shading film 38 can be in a white, black or any other color. However, it is preferable that the color is consistent with the display color of the pixels 40a to 40g or selected from colors so as to obtain a high contrast with respect to the display color.

As shown in FIG. 9B and FIG. 10, the electrophoretic display device 400 is configured such that the electrophoretic element 32 and the adhesive layer 33 are interposed between the first substrate 30 having a plurality of pixel electrodes 35a to 35d and 35X formed thereon and the second substrate 31 having the common electrode 37 formed thereon. The common electrode 37 is not connected to a wire to be electrically isolated in a manner similar to the first embodiment.

As shown in FIG. 9B, the pixel electrodes 35a to 35g each having a planar shape corresponding to the opening section of the light shading film 38 are formed on the first substrate 30. The pixel electrode 35X is formed in a rectangular shape in the planar region of the light shading film 38. On the other hand, as shown in FIG. 10, the common electrode 37 and the electrophoretic element 32 are also placed on the first substrate 30 where the pixel electrodes 35a to 35g and 35X are not formed, and the dummy pixel 40X and the pixels 40A to 40G share the common electrode 37 and the electrophoretic element 32.

In the electrophoretic display device 400 of the embodiment having the above configuration, by applying the high level potential VH or low level potential VL to the pixel electrodes 35a to 35g and 35X, the pixels 40a to 40g are set in the white or black display states in the same manner as the electrophoretic display device 100 according to the first embodiment. As a result, it is possible to display numerals or alphabets as a whole.

In particular, in the electrophoretic display device 400 of the embodiment, the placement of the dummy pixel 40X enables entire white display or entire black display of pixels 40a to 40g as the effective display section. For example, when all of the pixels 40a to 40g are set in the white display states, it is enough that the low level potential VL is applied to the pixel electrodes 35a to 35g and the high level potential VH is applied to the pixel electrode 35X of the dummy pixel 40X.

As shown in FIG. 10, since the common electrode 37 is common to the pixels 40a to 40g and the dummy pixel 40X, the electric potential Vcom of the common electrode 37 is stabilized to be the intermediate electric potential between the high level potential VH and the low level potential VL depending on the area ratio of the total area of the pixel electrodes 35a to 35g (low level potential VL) to the area of the pixel electrode 35X (high level potential VH). As a result, an electric field is generated between each of the pixel electrodes 35a to 35g and the common electrode 37, and then the electrophoretic elements 32 are driven, thereby causing all of the pixels 40a to 40g to be set in the white display states.

On the other hand, the electrophoretic element 32 of the dummy pixel 40X is set in the black state. However, as the light shading film 38 is formed above the dummy pixel 40X, a user cannot see the dummy electrode 40X. When all of the pixels 40a to 40g are to be set in the black display states, it is enough that the high level potential VH is applied to the pixel electrodes 35a to 35g and the low level potential VL is applied to the dummy electrode 35X of the dummy pixel 40X.

As described above in detail, the electrophoretic display device 400 of the embodiment enables the entire white display or entire black display which is not achieved by the electrophoretic display device 100 of the first embodiment by itself alone. As a result, there is no limitation on the display style and it is possible to provide the electrophoretic display device capable of performing various displays.

While the above embodiment is described by exemplarily showing the seven-segment type electrophoretic display device, it is possible to take an electrophoretic display device having the seven segments and an additional segment corresponding to a dot “.” or a comma “,”, a fourteen-segment type electrophoretic display device, or a sixteen-segment type electrophoretic display device. In addition, it is possible to apply a structure similar to the above to a dot matrix type electrophoretic display device having rectangular shaped segments arranged in a matrix fashion.

While the above embodiment is configured such that the dummy pixel 40X is disposed below the pixels 40a to 40g in the effective display region, it is possible to dispose the dummy pixel to any position as long as the dummy pixel shares the common electrode 37 and the electrophoretic element 32 with the pixels 40a to 40g in the effective display region. As shown in FIG. 9B by a chain double-dashed line, for example, it is possible to adopt a configuration in which a dummy pixel 40Y is disposed in a region surrounded by pixel electrodes 35a, 35b, 35g and 35f which are arranged in a square shape or a configuration in which a dummy pixel 40Z is disposed in a region surrounded by pixel electrodes 35c, 35d, 35e and 35g. It is also possible to take the configuration of the second embodiment for the electrophoretic display device 400 of the embodiment.

While the description is made by exemplarily showing the segment type electrophoretic display device in the first to fourth embodiments, it is of course possible to obtain a similar action effect even when the invention is adopted to an active matrix type electrophoretic display device.

Electronic Apparatus

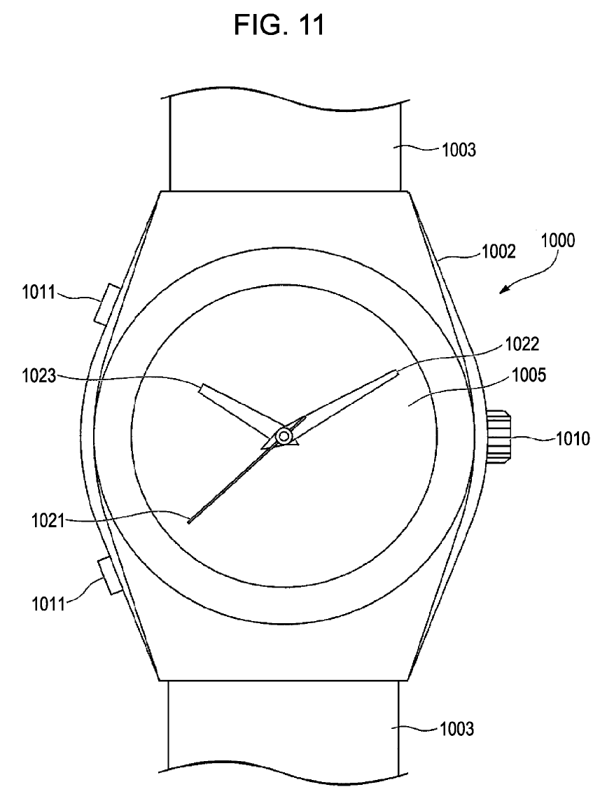

Next, an embodiment in which any one of the above electrophoretic display devices 100 to 400 is applied to an electronic apparatus, is described below. FIG. 11 is a front view of a wrist watch 1000. The wrist watch 1000 includes a watchcase 1002 and a pair of bands 1003 connected to the watchcase 1002. A display device 1005 having any one of the electrophoretic display devices 100 to 300 of the above embodiments, includes a second pointer 1021, a minute pointer 1022 and an hour pointer 1023 are provided to the front face of the watchcase 1002. A winding crown 1010 as an operation element and an operation button 1011 are provided to a side face of the watchcase 1002. The winding crown 1010 is coupled to a winding stem (not shown) provided in the watchcase 1002. The winding crown 1010 united with the winding stem can be pushed and pulled in multiple steps (e.g., two steps), and rotatable. On the display section 1005, an image to be a background, a character string such as a date or a time, the second pointer, the minute pointer and the time pointer can be displayed.

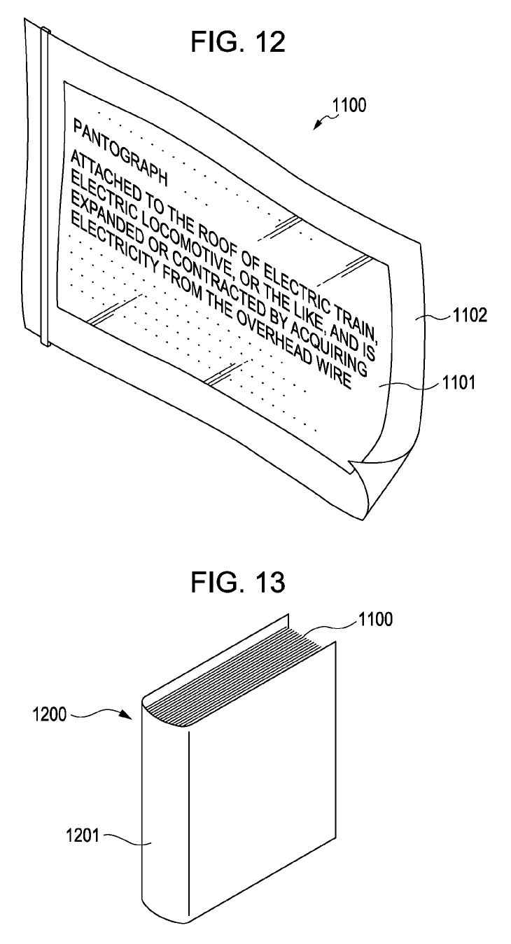

FIG. 12 is a perspective view showing a structure of an electronic paper 1100. The electronic paper 1100 has the electrophoretic display device of one of the above embodiments 100 to 300 at a display region 1101. The electronic paper 1100 having a flexibility is equipped with a body 1102 made of a rewritable sheet having a texture and a flexibility similar to an existing paper sheet.

FIG. 13 is a perspective view showing a structure of an electronic notebook 1200. The electronic notebook 1200 is configured such that the plurality of the above electronic papers 1100 are bunched and are sandwiched by a cover 1201. The cover 1201 is provided with a display data input unit (not shown) for inputting display data transmitted from, for example, an external device. With the above configuration, changing or updating of a display content can be carried out in accordance with the display data under a condition that the electronic papers are bunched.

Since either one of the electrophoretic display devices 100 to 300 is adopted to the wrist watch 1000, the electronic paper 1100 or the electronic notebook 1200, it is possible to achieve the electronic apparatus having the display section superior in a power saving property. Each of the above described electronic apparatuses exemplarily shows the preferable embodiment of the invention, but does not limit the scope of the invention. For example, the electrophoretic display device according to the invention can be preferably used for a display section of an electronic apparatus such as a mobile phone or a mobile audio apparatus.

The entire disclosure of Japanese Patent Application No. 2008-155316, filed Jun. 13, 2008 is expressly incorporated by reference herein.

What is claimed is:

1. A driving method for an electrophoretic display device, the electrophoretic display device including:
a first substrate;
a second substrate opposed to the first substrate;
an electrophoretic element having electrophoretic particles that is disposed between the first substrate and the second substrate;
a plurality of first electrodes formed on the electrophoretic element side of the first substrate; and
a second electrode formed on the electrophoretic element side of the second substrate, the second electrode being opposed to the plurality of first electrodes, and the driving method comprising:
making the second electrode be under an electrically isolated condition;
applying a first electric potential to a part of the plurality of first electrodes;
applying a second electric potential different from the first electric potential to a part of any other electrodes of the first electrodes.

2. The driving method according to claim 1, wherein
a total area of the first electrodes to be applied with the second electric potential is roughly the same as a total area of the first electrodes to be applied with the first electric potential.

3. The driving method according to claim 1, wherein
a total area of the first electrodes to be applied with the second electric potential is not less than one time but equal to or lower than three times a total area of the first electrodes to be applied with the first electric potential.

4. The driving method according to claim 1, further comprising:
varying at least one of the first and second electric potentials to be applied to the first electrode or varying a time period for applying the electric potential to the first electrode in accordance with an area ratio of a total area of the first electrodes to be applied with the first electric potential to a total area of the first electrodes to be applied with the second electric potential.

5. The driving method according to claim 1, wherein
the first electrode except the first electrode to be applied with the first or second electric potential is made under an electrically isolated condition.

6. The driving method for the electrophoretic display device according to claim 1, wherein
the first electrode to be applied with the first electric potential is disposed so as to be outside an effective display region of the electrophoretic display device.

7. A driving method for an electrophoretic display device, the electrophoretic display device including:
a first substrate;
a second substrate opposed to the first substrate;
an electrophoretic element having electrophoretic particles that is disposed between the first substrate and the second substrate;
a plurality of first electrodes formed on the electrophoretic element side of the first substrate; and
a second electrode formed on the electrophoretic element side of the second substrate, the second electrode being opposed to the plurality of first electrodes, and the driving method comprising:
displaying an image by applying a first electric potential to a part of the plurality of first electrodes, applying a second electric potential different from the first electric potential to a part of any other electrodes of the first electrodes and applying a predetermined electric potential to the second electrode;
refreshing by applying an electric potential corresponding to the first and second electric potentials in the displaying of the image to the plurality of first electrodes while making the second electrode be under an electrically isolated condition.

8. An electrophoretic display device comprising:
a first substrate;
a second substrate opposed to the first substrate;
an electrophoretic element having electrophoretic particles that is disposed between the first substrate and the second substrate;
a plurality of first electrodes formed on the electrophoretic element side of the first substrate; and
a second electrode which is formed on the electrophoretic element side of the second substrate, the second electrode being opposed to the plurality of first electrodes, wherein
the second electrode is in an electrically isolated condition.

9. The electrophoretic display device according to claim 8 further comprising:
a control section for controlling application of an electric potential to the plurality of first electrodes, wherein
the control section varies at least one of the first and second electric potentials to be applied to the first electrode or varies a time period for applying the electric potential to the first electrode in accordance with an area ratio of a total area of the first electrodes to be applied with the first electric potential to a total area of the first electrodes to be applied with the second electric potential.

10. The electrophoretic display device according to claim 9, wherein
the control section includes a table in which the ratio is correlated to the first or second electric potential or the potential applying time period.

11. The electrophoretic display device according to claim 8, wherein
at least a part of the first electrodes is disposed out of an effective display region of the electrophoretic display device.

12. An electronic apparatus comprising:
the electrophoretic display device according to claim 8.
